(19) United States
(12) Patent Application Publication
(10) Pub. No.: US 2007/0179869 A1
(43) Pub. Date: Aug. 2, 2007

(54) Customer inventory enhancement system

(75) Inventor: Gordon Brooks Cochrum, Little Elm, TX (US)

Correspondence Address: WILLIAM R. GUSTAVSON, SUITE 1185, 9330 LBJ FRWY., DALLAS, TX, 75243, US

(73) Assignee: Four Seasons, a division of Standard Motor Products, Inc.

(21) Appl. No.: 11/343,902

(22) Filed: Jan. 31, 2006

(51) Int. Cl. G06Q 10/00

(52) U.S. Cl. 705/29

(57) ABSTRACT

A system, apparatus and process are disclosed for enhancing the business of a customer. The system inputs the inventory of individual components held by the customer and compares the individual components to a table of kits listing the individual components used in each kit. The system provides the customer with information regarding the kits that are formed by the customer's inventory of individual components and permits the customer to sell the individual components as kits or virtual kits without requiring the individual components to physically be inventoried in a single box or container.

### BACKGROUND OF THE INVENTION

In the automotive industry, and in particular in the aftermarket automotive air conditioning repair business, it is common to require a number of individual components to complete a specific repair job on an automobile. One example is the replacement of an air conditioning compressor in an automobile. Such a repair requires not only the replacement compressor, which can be a new compressor, a remanufactured compressor or an enhanced design compressor(referred to as a premium compressor), but also the other components necessary to perform the repair. For example, it may be necessary to provide a new accumulator/filter drier and expansion valve or orifice tube. Also, the system must be flushed with a flushing agent and oil added to the compressor for lubrication, apart from the need to refill the system with refrigerant.

A parts supplier, hereinafter referred to as the customer, will typically stock all the individual components needed for the repair. The end user, such as a repair shop, will typically purchase from the customer whatever components it does not already have on hand to complete the repair. In the past, the customer has typically stocked in inventory all the individual components that may be needed by the end user. In addition, some customers have on hand actual kits containing all the necessary individual components in a box to do the repair on a particular automobile. Selling a kit can increase customer sales as the end user will buy all the needed components from the customer. Also, selling a kit can help assure a more satisfactory repair. For example, when the end user has in the kit the needed flush, the end user is more likely to properly flush the system, rather than skipping this step of the repair. However, as there are many thousands of different combinations of individual components necessary to service the industry, inventorying all the necessary kit boxes leads to very expensive and complicated inventory concerns for the customer. A need exists to facilitate the operation of the customer to more efficiently serve the end user and, where possible, sell more inventory.

### SUMMARY OF THE INVENTION

In accordance with one aspect of the present invention, an information processing method is provided which is used to correlate individual components in a customer inventory to a kit containing selected ones of the individual components. The method includes the step of receiving inventory information from the customer containing the customer inventory of the individual components. A comparison is made of the customer inventory of individual components to a table of kits listing the individual components used in the kits to determine the kits that are formed by the customer inventory of individual components to inform the customer what kits are in inventory.

In accordance with another aspect of the present invention, the method prepares a catalog of the kits in inventory for the customer. The method can extract individual components from the customer inventory of individual components that are not part of the kits in inventory. This can be used to identify orphan components and to order the additional components needed to complete a kit.

In accordance with another aspect of the present invention, a virtual kit having a plurality of individual components is formed by receiving inventory information from a customer containing the customer inventory of the individual components and comparing the customer inventory of individual components to the list of individual components necessary for the virtual kit to insure that all the individual components are in inventory to form the virtual kit.

### BRIEF DESCRIPTION OF THE DRAWINGS

A more complete understanding of the invention and its advantages will be apparent from the following Detailed Description, taken in conjunction with the accompanying Drawings, in which:

FIG. 1 is an illustration of the main switchboard;

FIG. 2 is an illustration of the screen used when adding a new customer;

FIG. 3 is an illustration of the inventory review by zone sales screen;

FIG. 4 is an illustration of the inventory review by kit component screen;

FIG. 5 is an illustration of the kit catalog review delete kit screen;

FIG. 6 is an illustration of the kit catalog review add kits screen;

FIG. 7 is an illustration of a catalog page presented to the customer for printing;

FIG. 8 is an illustration of a components guide page presented to the customer;

FIG. 9 is an illustration of an order worksheet page presented to the customer;

FIG. 10 is an illustration of an inventory issues page presented to the customer; and

FIG. 11 is a flow chart that schematically shows the operation of a system forming a first embodiment of the present invention.

### DETAILED DESCRIPTION

With reference now to the figures, a system is disclosed that allows a customer to be aware of what virtual kits (hereinafter kits) it has in inventory that are formed by one or more individual components in its inventory. A virtual kit is a kit of individual components necessary to perform some task, such as an automotive repair. With a virtual kit, the customer does not need to maintain all of the individual components physically within a single box, but can keep them separate in inventory so that an individual component is more quickly sold to the end user by being part of a virtual kit sold to the end user rather than being stored in an actual box kit and sold only when that box kit is sold. For example, an expansion device may be common to many applications and be listed as part of many virtual kits. That expansion device is sold and out of inventory, generating profit for the customer, upon the sale of the applied virtual kit that lists it as a part thereof. In contrast, an expansion device placed in a conventional box kit will only be sold and generate profit for the customer when an end user needs to buy the kit for the specific application the box kit was made for.

FIG. 11 is a drawing that shows a conceptual structure of a system 10 in accordance with the present invention. The system 10 will typically be used by a salesman, likely on a portable or laptop computer. Thus, the first action in the system leads to step 14, installing the program on the computer. Step 16 involves obtaining the relevant inventory and desired pricing scheme from the customer. Usually, the inventory will be in computerized format. Step 18 involves loading the customer inventory and pricing scheme into the computer. If the customer's inventory is in computerized format, this portion is straightforward. However, the inventory could be added manually, if necessary. Step 18 also relates the customer inventory to the potential universe of virtual kits and provides an initial catalog of the virtual kits that the customer can advertise are in stock. If no modification is needed to the catalog, step 22 provides the catalog ready for printing. If modifications are needed, Steps 24 and 26 allow parts or kits to be added to or deleted from the catalog as desired prior to proceeding to step 22.

In the present market for automotive air conditioning compressor replacement repair, over 2000 virtual kits can be identified to service the over 11,000 applications found on the over 8000 different vehicle types in operation. To stock over 2000 boxed kits would be impractical.

For example, in the aftermarket automotive air conditioning servicing industry, the replacement of a compressor on a particular automobile should not only require the end user to buy the replacement compressor from the customer, but also to purchase the other individual components needed to do a proper repair, such as the proper accumulator/filter drier, expansion device, flush and oil for the particular automobile. The accumulator and filter drier can be supplied with or without a hose assembly. The expansion device can be an expansion valve or an orifice tube. Orifice tubes are typically color coded. The system of the present invention informs the customer if it has the necessary individual components in inventory to sell all the components necessary for the repair to the end user in the form of a virtual kit, not only providing the opportunity for the customer to enhance sales, but also to provide the end user with all the individual components needed to do the best possible repair.

The system is oriented to the business of the supplier of the individual components to the customer, typically the supplier is the manufacturer of the individual components, but the system can clearly be used by the customer as well as any other interested party.

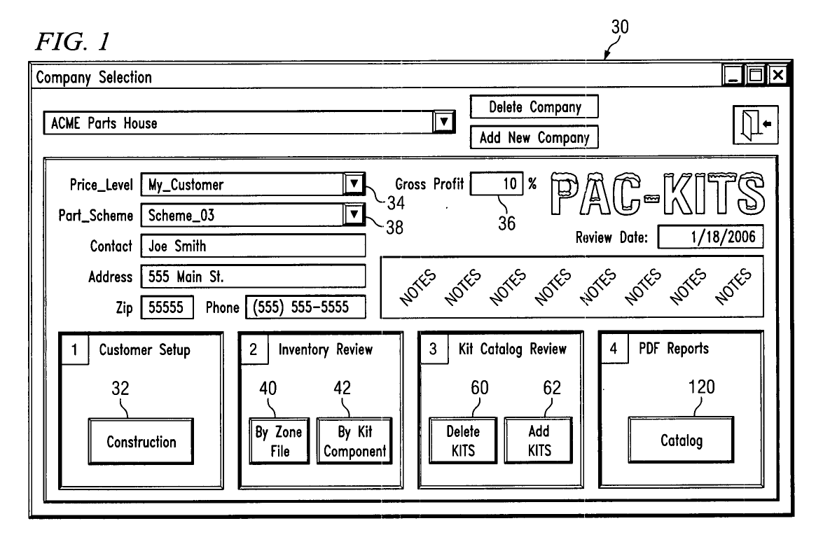

The system is implemented in the Access software available in the Microsoft Office Suite running on a PC computer. The utilities used to produce the system include Tables, Queries, Forms and Visual Basic for Apps. The printing can be done with CutePDF writer. However, the system can be implemented in any appropriate software or hardware. The hardware will typically be a computer including a CPU, a main storage section provided with a semiconductor memory such as RAM(and/or ROM) and an auxiliary storage section such as a hard drive disk. The salesman for the supplier will typically operate the system through the graphical user interface in the Access program on a portable computer. FIG. 1 illustrates the main switchboard master screen 30 of the system. The master screen 30 sets forth four major stages, Customer Setup, Inventory Review, Kit Catalog Review and PDF Reports.

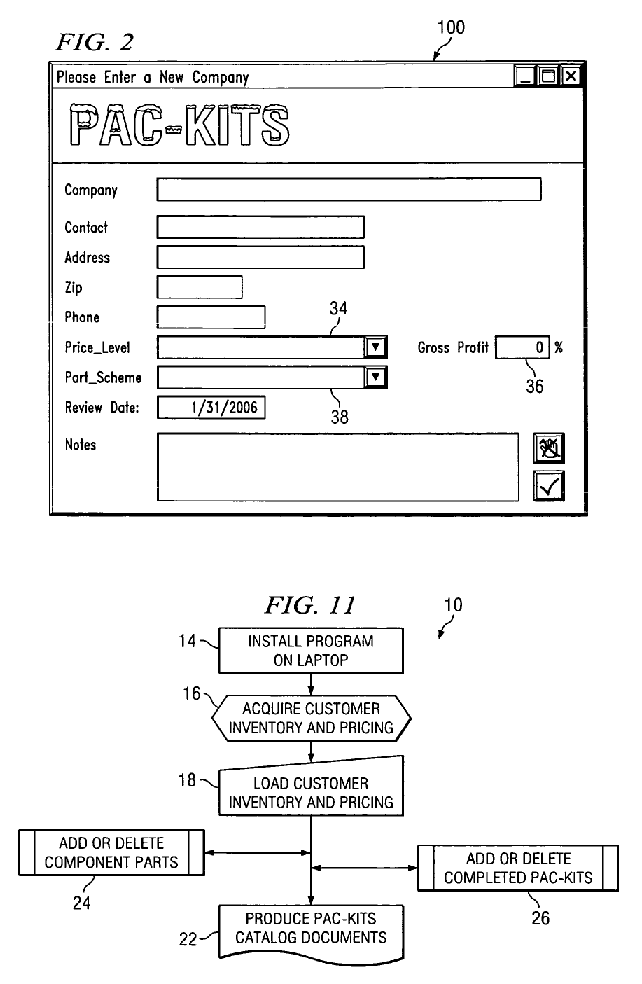

Each customer to be serviced under the system will be input in the first stage of the system with relevant information such as name, address, contact information, and telephone number through a graphical user interface 100 by the operator as shown in FIG. 2. This first stage is customer set up and is entered by clicking on the construction button 32 on screen 30. Also input will be the price level and gross profit to be associated with the customer which will appear in windows 34 and 36. The same information will appear on both screens 30 and 100, allowing the operator to change any data directly on screen 30 also if desired. One of ten or more part schemes is also selected and the selected part scheme appears in windows 38. One of the part schemes can be chosen for each customer. This permits the customer to list a unique part number for a virtual kit. Other customers may sell the same kit, but it would have a different part number, being part of a different part scheme. For example, under part scheme 1, the part number of a given virtual kit for customer 1 may be 1000R, where as the very same virtual kit would have a part number 1015R under part scheme 2 for customer 2 and part number 1123R under part scheme 3 for customer 3, etc.

Examples of price levels that can be chosen are Jobber, Straight W/D(Warehouse/Distributor), W/D with API, W/D with API with Promo, Single Source, Single Source with Promo and a category called My Customer. Use of My Customer allows special uploaded prices. The salesman can construct a special or bulk pricing file for general use by the salesman or specific to a customer by simply associating a copy of the empty customer price table with the general use or customer and then incorporating therein such data as is pertinent from the master pricing file. Selected prices can then be changed in this special or bulk pricing table as are needed to fit in the salesman's needs or customer's pricing scheme.

The system will include an empty customer price table in computer memory that may only list the available part numbers under one column and a second column headed price, but without any data entries for price. The system also includes a master pricing file that lists all parts and the standard prices, as well as other data. The master pricing file will reside in the computer memory and will only be updated or changed when the supplier needs to. The salesman will typically never alter the master pricing file.

In the construction step 32 in stage 1, the system combines the price scheme selected for the customer, the column pricing file set up for the customer and the customer's inventory list, if one is available.

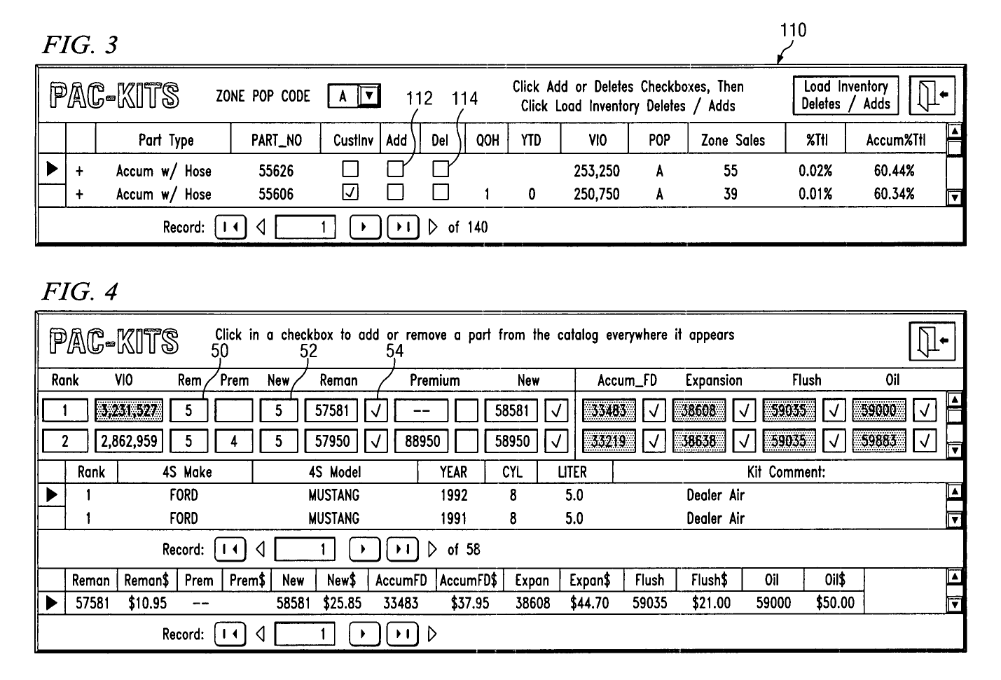

The system provides a powerful tool for inventory review. As seen in FIGS. 3 and 4, inventory review stage two allows selection of either a review by zone file by clicking button 40 or by kit component by clicking button 42. Clicking button 40 calls up a file 110 as seen in FIG. 3 that lists individual components by zone. Typically, zones A, B, C, D, W and F are used. Zone A includes those components which are most often sold. Zones B, C, D and F include components which have progressively fewer sales. For example, components included in zone F would be sold vary rarely and would likely not be kept in stock and would need to be a special order from the manufacturer if an end user wishes to purchase the component. Zone W includes those components that should be stocked in a warehouse, rather than at the sales location. For each component listed, the zone file 110 lists the part type, part number, the number of the parts in inventory, the QOH(quantity on hand), YTD(sales of the part year to date), VIO on which the part is used, the zone the part is in(here zone A since zone A components were chosen to be listed), the sales of the part for all customers and percentages of that parts sales relative to other type sales, etc. Boxes 112 and 114 allow the operator to click on the appropriate box to add or delete the component from the customer inventory.

Clicking button 42 calls up a file as shown in FIG. 4 that lists a number of key data items in column form that can be searched in many useful ways. Each kit forms one row, with the rows typically ranked by the number of vehicles in operation (VIO) that the kit applies to. The kit applicable to the largest number of vehicles in operation is given the rank of one, and so forth. Thus, in FIG. 4, the first ranked kit applies to 3,231,527 vehicles in service and fits Ford Mustangs. The columns in a given row list the part number of the individual components of the kit, and also identify how many components are in the kit. Each kit will typically have a choice between a remanufactured (reman) compressor, a new compressor(new) and often a premium new compressor(prem) that is an improved version of the original compressor design. Pricing is displayed on the bottom of the screen. Also typically identified are the part numbers for the accumulator/filter device, the expansion valve/orifice device, flush and oil. Thus, in FIG. 4, the first ranked kit is available with either a remanufactured compressor part number 57581 or a new compressor part number 58581 and has accumulator part number 33483, expansion device 38608, flush 59035 and oil 59000. The virtual kit is noted as having five components, as listed in boxes 50 and 52 written in the rem and new column, depending on choice of compressor.

A check mark appears in a small box with each column of a row if the component in that column and row is available in the customer's inventory. For example, box 54 is associated with remanufactured compressor part number 57581 with the first ranked kit and contains a check mark, indicating that compressor is in stock. A filter step provided in a drop down menu in the program permits the operator to find the next appearance of a particular part number identifying a particular component in the list or to find all kits that include that component. If the operator knows a particular component is not in inventory, uncheck marking that component in any of the kits automatically unchecks the component in all the kits in which it is used. For example, part number 38621 may represent a particular expansion valve. Uncheck marking an entry with this part number will uncheck mark all entries with this part number. This is a very powerful feature.

By clicking on or entering into a given row, the vehicle makes and models that the kit applies to are automatically displayed below the main list. The operator can also filter by the number of components. Thus the operator can determine what kits have only four components, for example. This filter can be used to identify kits that have missing components in the customer's inventory.

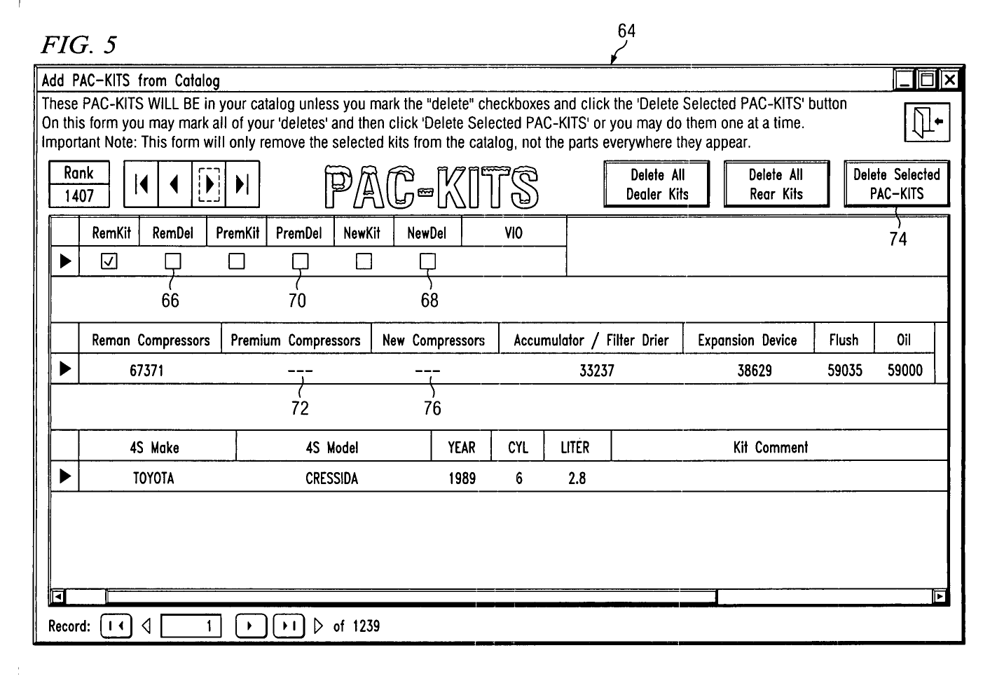

The third stage of the system allows the operator to add and delete entire kits from the catalog of kits by clicking on buttons 60 and 62. For example, to delete a kit, it is only necessary to click on the delete kit button 60, which calls up a screen 64 as seen in FIG. 5 listing kits by order of rank. If kit 1407 is to be removed, for example(which may not have a prem or new compressor), it is only necessary to click on the delete reman button 66 and then a delete kit button 74. This will delete kit 1407 from the catalog. As noted, in this case, kit 1407 had only a reman compressor as can be seen from the fact that boxes 72 and 76 list no part number for a premium or new compressors. If the kit also has a prem or new compressor, it will be necessary to click on the delete prem button 70 or delete new button 68 as well. It is important to understand that deleting a kit does not remove the components used in that deleted kit from any other kit in which they are used.

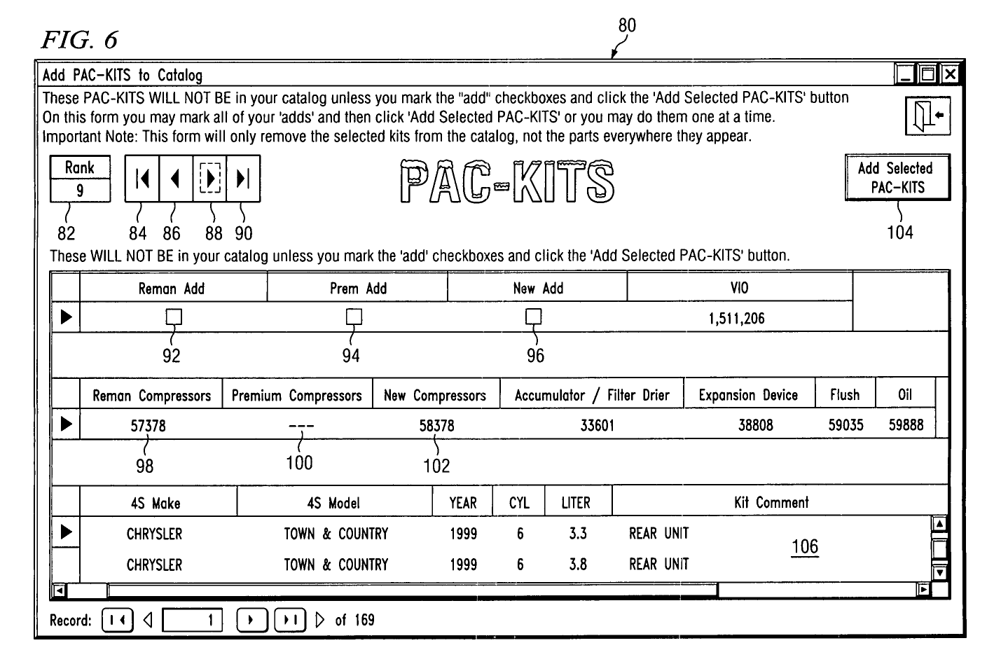

A kit can be added in a similar manner as shown in screen 80 in FIG. 6 brought up by clicking on button 62. A selection is made of the virtual kit to be added by entering its rank in box 82. Arrows 84, 86, 88 and 90 allow the operator to scroll through the library of virtual kits by rank. Clicking arrow 84 brings up the first ranked kit. Clicking arrow 86 selects the next higher ranked kit than the one currently displayed. Clicking arrow 88 selects the next lower ranked kit than the one currently displayed. Clicking arrow 90 selects the lowest ranked kit. To add the kit, a check is entered into the boxes 92, 94 and 96 as appropriate to add reman, prem or new compressor kits. As is clear from boxes 98, 100 and 102, this kit only comes with reman or new compressors as the appropriate part numbers are in their respective boxes and no part number is listed for a prem compressor. After the selection of the boxes 92, 94 and 96 for a given kits are appropriately marked, the kit can be added to the catalog by clicking on the add selected kits button 104. In area 106, the applications of the selected kit are displayed.

The system correlates the inventory review file and the kit catalog. The system contains all the possible kits, but lists in the catalog for the particular customer only those kits shown on the inventory review file of the customer. For example, if the number one ranked kit shows no inventory of compressors, it will not be in the kit catalog list for the customer. However, clicking the add kit button 62 in the kit catalog review stage 3 will bring up screen 80 with access to all the possible kits. Each kit will have an indicator showing the status of the kit as being in the catalog or not. In the example shown in FIG. 6, the number nine ranked kit will have an indicator showing the number nine ranked kit is not in the catalog. As discussed above, the operator can click on this indicator to add back the number nine ranked kit into the catalog. Adding the kit back into the catalog will only put the row for the kit back in the inventory review sheet, but not alter the indicators on the inventory review sheet which show that none of the compressors in that row are in stock. Thus, adding to or deleting kits from the catalog does not effect the inventory of the customer reflected in the inventory review because, of course, it has not effected the actual inventory of the customer.

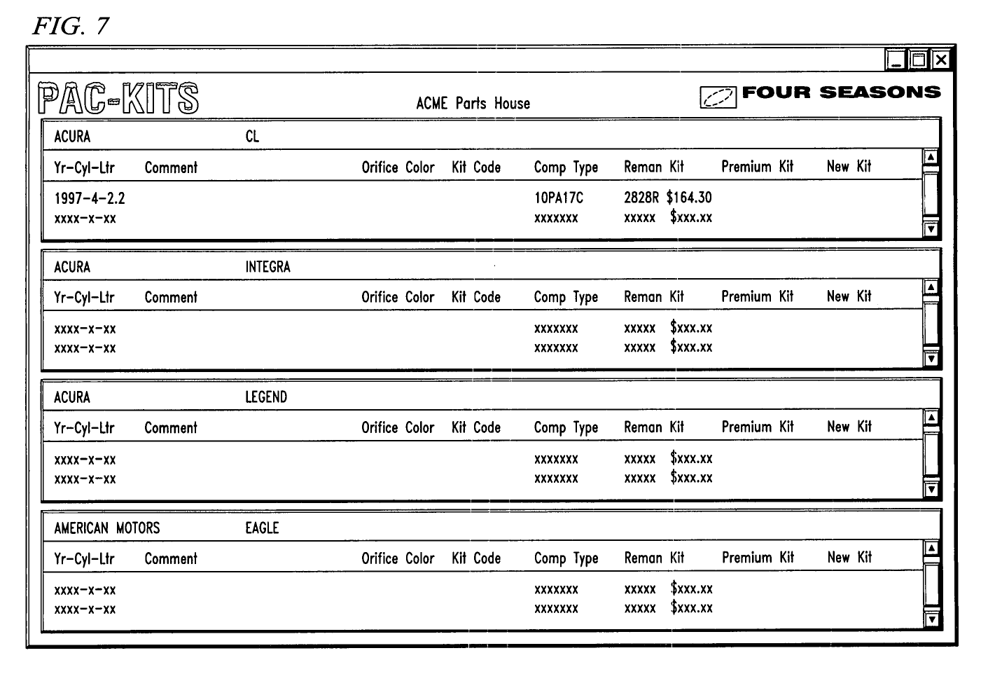

The kit catalog review fourth stage generates a catalog in pdf format by simply clicking on button 120 that the operator can forward to the customer to be printed and distributed to the customer's sale personnel. The catalog will be generated with the customers name thereon and will save the customer the cost and effort of preparing its own catalog. The catalog will list the automobile make, model, year, number of engine cylinders, engine displacement, pertinent comments and the part number and price of any reman, new and prem kit available for that automobile. FIG. 7 is an example of a page of the catalog. In addition, the catalog will have a components guide which lists each kit number and the part number of the compressor, accumulator/filter drier, expansion device, flush and oil in that kit. The counter-person selling the kit can consult this components guide to find each of the individual components on the shelves to form the complete kit. FIG. 8 is an example of a page of the components guide.

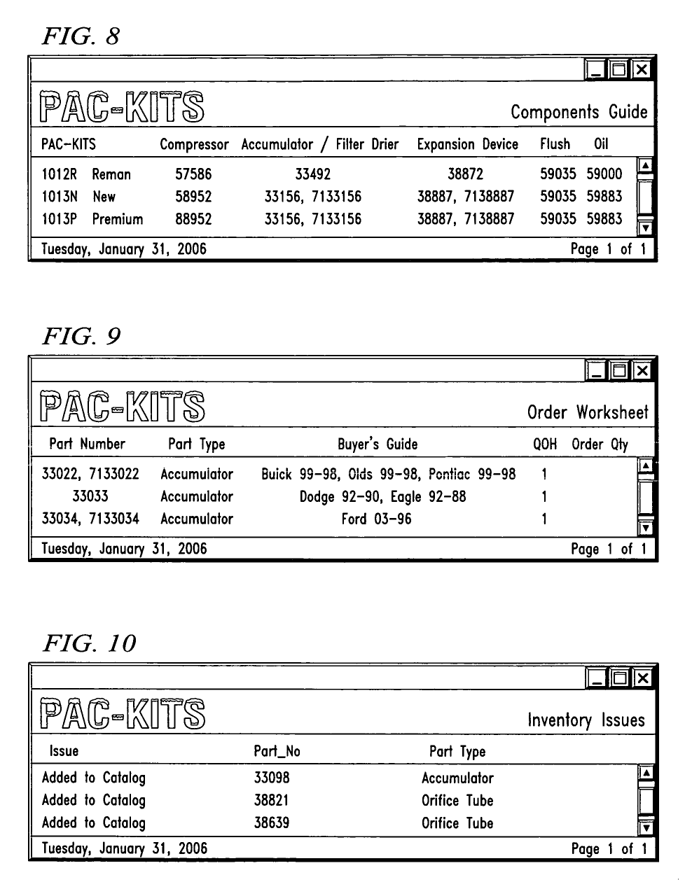

The system can also print out an order worksheet. The order worksheet will list the part numbers of the component, their type, the quantity on hand and a column for order quantity. An example of a page from the order worksheet is shown in FIG. 9. This provides an easy mechanism for the customer to indicate what components they have and what they need to order from the supplier. The part numbers can be proprietary numbers as well as industry standard numbers such as API numbers.

The system will also provide an inventory issues sheet. This will list items added and deleted. An example of a page from the inventory issues sheet is shown in FIG. 10. It will also list components that are in stock that are not listed in the catalog because the other components necessary to make a kit with the in stock component are not on hand. This provides the customer with the option to order the missing components from the supplier to form a complete kit.

As can be appreciated, the system provides numerous advantages. The customer no longer need stock a conventional kit with the individual components packed in a single box. The customer has a catalog of the virtual kits that can quickly be assembled from the individual components in the inventory of the customer for sale over the counter to the end user. This increases the sales of the customer as the end user can purchase the virtual kit, thus buying not only the compressor, but the various other individual components, accumulator, flush, oil, etc. necessary to undertake a proper repair. It also increases the sales of the supplier as the customer will likely buy from the supplier all the individual components needed for the kit. Another advantage for the end user is the fact that the purchase of a kit from the customer insures that all the necessary steps to a proper repair are done with the proper components, allowing the supplier to warrant the repair.

Many enhancements can be made to the system. For example, the customer can be queried as to the specialty of the customer, zip code or the radius of service of the customer to tailor the rank of the kits based on the VIO in the specialty of the customer, zip code or the radius of service of the customer so that the customer knows what kits to have in inventory. The system can also rank kits by the VIO in a given state or county, rather than the 48 continental states combined. The system can also take into account applications that fail more or less frequently than the industry norm to insure the optimum number of kits are available in the customer inventory. Corporate POP codes can be used. Corporate descending sales can be used. Additional part descriptions can be provided. Catalogs can be printed with or without pricing. It can be provided with the ability to print only the top kits in a state, region or country or to print only the top kits made up of top selling parts in a state, region or country.

The system can also be implemented through an electronic provider over the Internet. Such a provider is Wrenchead, Inc. This will permit a jobber or installers access an online presentation of the virtual kit catalog for lookup and sale of virtual kits by way of a secure account setup and access. The end result is a print ticket at the associated jobbers location.

Data flow within the system, including transfer of a catalog to the customer or receipt of the inventory information of the customer can be made over a network. The network can be any communication line network for executing data transfer and, more specifically, various communication line networks, constituted by electric communication lines(including optical communication lines), such as the Internet, LAN, WAN, CATV and ICN(Inter Community Network). The connecting method to the network may be a regular connection using a dedicated line, or a temporary connection, such as a dial up connetion using telephone lines like analog lines or digital lines (ISDN). Moreover, its transfer method may be a radio method or a cable method.

While several embodiments of the present invention have been illustrated in the accompanying drawings and described in the foregoing Detailed Description, it will be understood that the invention is not limited to the embodiments disclosed, but is capable of numerous rearrangements, modifications and substitutions of parts and elements without departing from the scope and spirit of the invention.

1. An information processing method is provided which is used to correlate individual components in a customer inventory to a kit containing selected ones of the individual components comprising the steps of:
receiving inventory information from the customer containing the customer inventory of the individual components;
comparing the customer inventory of individual components to a table of kits listing the individual components used in the kits to determine the kits that are formed by the customer inventory of individual components to inform the customer what kits are in inventory.

2. The method of claim 1 further comprising the step of preparing a catalog of the kits in inventory for the customer.

3. The method of claim 1 further comprising the step of extracting individual components from the customer inventory of individual components that are not part of the kits in inventory.

4. The method of claim 1 wherein the individual components are used in the repair of an automotive air conditioner.

5. The method of claim 4 wherein at least one individual component is an air conditioning compressor.

6. A virtual kit having a plurality of individual components formed by receiving inventory information from a customer containing the customer inventory of the individual components and comparing the customer inventory of individual components to a list of individual components necessary in the virtual kit to insure that all the individual components are in inventory to form the virtual kit.

7. The virtual kit of claim 6 wherein at least one of the individual components is an air conditioning compressor.

8. A system for correlating individual components in a customer inventory to a virtual kit containing selected ones of the individual components comprising:
inventory information from the customer containing the customer inventory of the individual components;
an apparatus to compare the customer inventory of individual components to a table of kits listing the individual components used in the kits to determine the kits that are formed by the customer inventory of individual components to create data informing the customer what kits are in inventory.

9. The system of claim 8 wherein the individual components are components for the repair of automotive air conditioning systems.

10. The system of claim 8 wherein the kits included components to repair an automotive air conditioning system.

11. The system of claim 8 wherein the kits are ranked in the table by the number of automobiles in operation in which the kit can be used.

12. The system of claim 11 wherein the kits are ranked in the table by the number of automobiles in operation in a state in which the kit can be used.

13. The system of claim 11 wherein the kits are ranked in the table by the number of automobiles in operation in the area of business of the customer in which the kit can be used.

14. The system of claim 11 wherein the kits are ranked in the table by the number of automobiles in operation of a specific type serviced by the customer in which the kit can be used.
